(19) United States
(12) Patent Application Publication
(10) Pub. No.: US 2003/0159266 A1
(43) Pub. Date: Aug. 28, 2003

(54) Fabricating method of photosensitive drum for electrophotographic image forming apparatus

(75) Inventor: Jin-Soo Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/238,641

(22) Filed: Sep. 11, 2002

(30) Foreign Application Priority Data
Feb. 22, 2002 (KR) 2002-9483

(51) Int. Cl. G03G 5/00; B23P 11/00

(52) U.S. Cl. 29/430; 430/130; 29/429; 29/527.4

(57) ABSTRACT

A method of fabricating a photosensitive drum includes fabricating a rotary drum and a cylindrical photosensitive belt that closely contacts a circumferential surface of the rotary drum in an electrophotographic color image forming apparatus. The photosensitive belt is in contact with the circumferential surface of the rotary drum using shrinkage and expansion of the rotary drum according to a temperature change of the rotary drum. Thus, it is easy to fabricate the photosensitive drum. Also, since an inexpensive photosensitive belt is used, a fabricating cost of the photosensitive drum can be reduced.

### CROSS-REFERENCE TO RELATED APPLICATIONS

This application claims the benefit of Korean Patent Application No. 2002-9483, filed Feb. 22, 2002, in the Korean Intellectual Property Office, the disclosure of which is incorporated herein by reference.

### BACKGROUND OF THE INVENTION

1. Field of the Invention

The present invention relates to a fabricating method of a photosensitive drum for an electrophotographic image forming apparatus, and more particularly, to a fabricating method of a photosensitive drum for an electrophotographic image forming apparatus, which includes a rotary drum and a cylindrical photosensitive belt that is attached on a circumferential surface of the rotary drum.

2. Description of the Related Art

In general, an electrophotographic image forming apparatus radiates light onto a photoreceptor, forms a latent electrostatic image on the photoreceptor corresponding to a desired image, develops the latent electrostatic image with toner of a predetermined color to form a toner image on the photoreceptor, and prints the toner image of the photoreceptor to paper.

The electrophotographic image forming apparatus uses a photosensitive belt or a photosensitive drum as the photoreceptor. FIG. 1 is a schematic view of the configuration of a general electrophotographic color image forming apparatus using the photosensitive belt. Referring to FIG. 1, the electrophotographic color image forming apparatus includes a photosensitive belt 20, an eraser 12, a charger 14, a laser scanning unit (LSU) 16, a developer unit 18, and a transfer belt 30. The photosensitive belt 20 is supported by a plurality of rollers 10a, 10b, and 10c to travel in a continuous path. The charger 14 charges the photosensitive belt 20 with a predetermined voltage. The LSU 16 radiates light onto the charged surface of the photosensitive belt 20 to form a latent electrostatic image corresponding to a desired image on the photosensitive belt 20. The developer unit 18 includes a plurality of developers 18a, 18b, 18c, and 18d which are serially disposed along a traveling direction of the continuous path of the photosensitive belt 20 to develop the latent electrostatic image with four colors of yellow (Y), magenta (M), cyanogens (C), and black (BK) to form a visual image. The transfer belt 30, to which the visual image developed on the photosensitive belt 20 is transferred, prints the visual image on a paper. Here, reference numeral 14 represents an eraser.

In the above-described configuration, to form the visual image, the charger 14 charges the photosensitive belt 20 with the predetermined voltage. Next, the LSU 16 radiates the light onto the charged surface of the photosensitive belt 20 to form the latent electrostatic image corresponding to the desired image on the photosensitive belt 20. The latent electrostatic image is developed with toners having four colors which are supplied from the yellow developer 18a, the magenta developer 18b, the cyan developer 18c, and the black developer 18d, respectively. The developed latent electrostatic images are overlapped on and transferred to the transfer belt 30 to form a visual image, and the visual image is printed on the paper.

However, the photosensitive belt 20 may laterally move beyond the continuous path, which causes a registration failure that degrades the uniformity of the visual image. Thus, an additional steering unit is necessary to prevent the registration failure.

FIG. 2 is a schematic view of a configuration of another general electrophotographic color image forming apparatus using a photosensitive drum. Here, elements that are the same as those in FIG. 1 are described with the same numerals. Since their descriptions are as previously described, any further descriptions about the elements will be omitted.

The electrophotographic color image forming apparatus shown in FIG. 2 uses a photosensitive drum 40 as the photoreceptor, instead of the photosensitive belt. Thus, a steering unit is unnecessary to prevent a registration failure.

However, the photosensitive drum 40 is manufactured by a method of dipping a cylinder into a photosensitive solution to form a photosensitive film on a surface of the cylinder. Thus, the manufacturing method of the photosensitive drum 40 is difficult, and it costs a great deal to manufacture the photosensitive drum 40.

### SUMMARY OF THE INVENTION

To solve the above and other problems, it is an object of the present invention to provide a method of fabricating a photosensitive drum for an electrophotographic image forming apparatus in which a photosensitive drum can easily be fabricated, and in which a fabricating cost thereof can be reduced.

Additional objects and advantageous of the invention will be set forth in part in the description which follows and, in part, will be obvious from the description, or may be learned by practice of the invention.

Accordingly, to achieve the above and other objects, there is provided a method of fabricating a photosensitive drum having a rotary drum and a cylindrical photosensitive belt that closely contacts a circumferential surface of the rotary drum in an electrophotographic color image forming apparatus. In the method, the photosensitive belt is in contact with the circumferential surface of the rotary drum using shrinkage of the photosensitive belt and expansion of the rotary drum according to temperature changes of the rotary drum.

Here, the rotary drum is cooled from an ambient temperature down to a predetermined temperature so as to be shrunk. The photosensitive belt is inserted around the shrunk rotary drum. The shrunk rotary drum is restored to an original volume at the ambient temperature so that the photosensitive belt closely and tightly contacts the circumferential surface of the rotary drum.

### BRIEF DESCRIPTION OF THE DRAWINGS

These and other objects and advantageous of the invention will become apparent and more readily appreciated from the following description of the preferred embodiments, taken in conjunction with the accompanying drawings of which:

FIG. 1 is a schematic view of a configuration of a general electrophotographic color image forming apparatus using a photosensitive belt;

FIG. 2 is a schematic view of the configuration of another general electrophotographic color image forming apparatus using a photosensitive drum;

FIG. 3 is a schematic view of the configuration of an electrophotographic color image forming apparatus using a photosensitive drum according to an embodiment of the present invention;

FIG. 4 is a cross-sectional view of the photosensitive drum shown in FIG. 3; and

FIG. 5 is a view explaining a method of fabricating the photosensitive drum shown in FIG. 4.

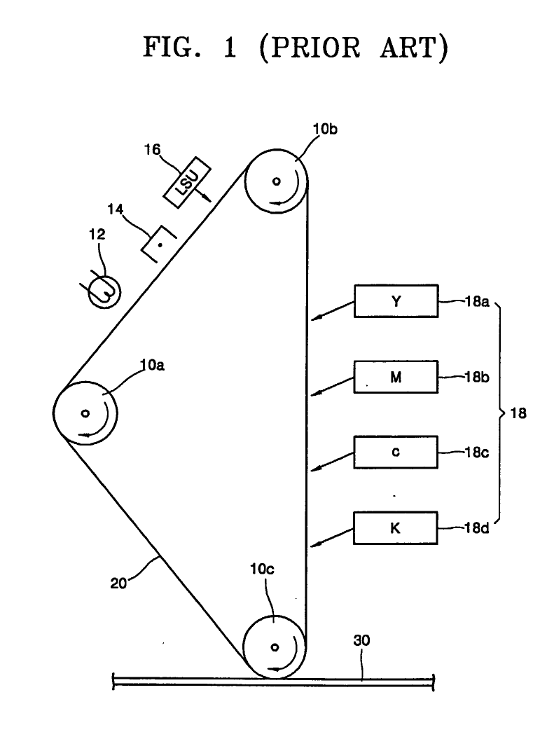

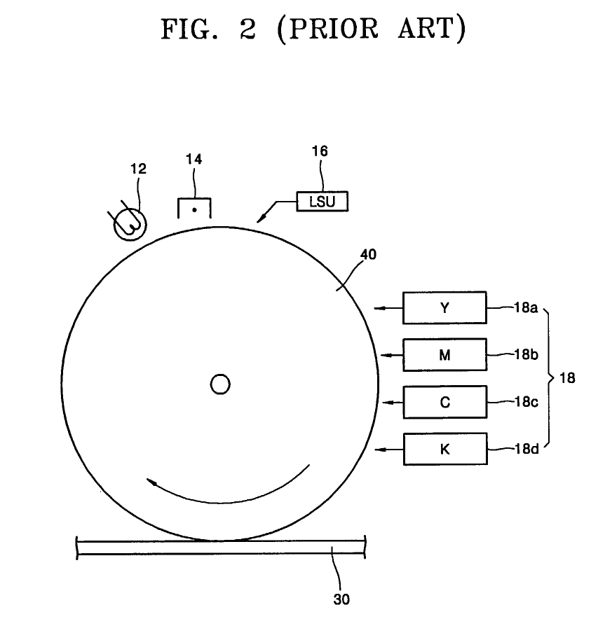

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

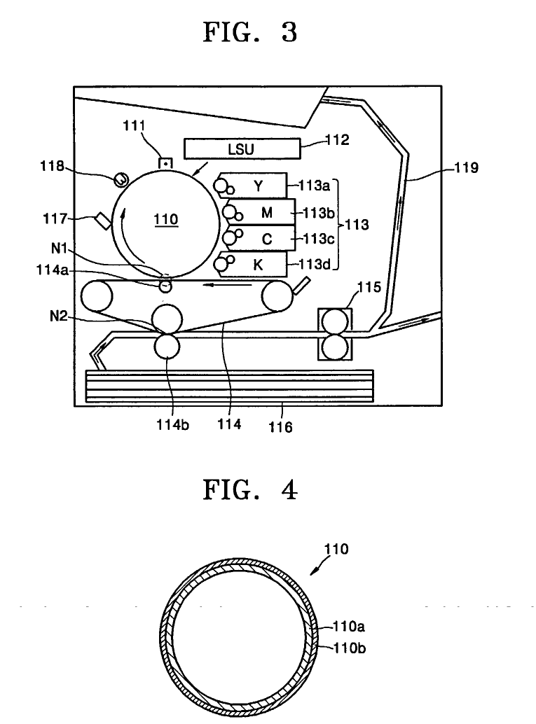

FIG. 3 is a schematic view of a configuration of an electrophotographic color image forming apparatus using a photosensitive drum according to an embodiment of the present invention. Referring to FIG. 3, the electrophotographic color image forming apparatus includes a photosensitive drum 110 that is a photoreceptor, a charger 111, a light scanning unit (LSU) 112, a developer unit 113, a transfer belt 114, a first transfer roller 114a, a second transfer roller 114b, and a fixing unit 115. The charger 111 charges the photosensitive drum 110 with a predetermined voltage. The LSU 112 radiates light onto a charged surface of the photosensitive drum 110 to form a predetermined latent electrostatic image.

The developer unit 113 develops the latent electrostatic image with toners having four colors of yellow (Y), magenta (M), cyanogens (C), and black (BK). The four color images developed on the photosensitive drum 110 are serially (sequentially) transferred to the transfer belt 114 to be overlapped on the transfer belt 114 to form a developed image. The first transfer roller 114a transfers the developed image on the photosensitive drum 110 to the transfer belt 114. The second transfer roller 114b transfers the developed image of the four color images overlapped on the transfer belt to a sheet of paper. The fixing unit 115 hot-presses the paper to permanently fix the transferred image on the paper.

Here, the developer unit 113 has four developers 113a, 113b, 113c, and 113d which are spaced apart from the photosensitive drum 110 and sequentially moved toward the photosensitive drum 10 by a contact unit (not shown) to control developer rollers disposed at respective front tips of the developers 113a, 113b, 113c, and 113d to be electrically in contact with the photosensitive drum 110. Here, reference numeral 116, 117, 118, and 119 represent a paper cassette, a cleaning blade cleaning the photosensitive drum 110, an eraser, and a transfer path of the paper, respectively.

In the above-described configuration, a method of forming the developed image will be described. The charger 111 charges the photosensitive drum 110 with the predetermined voltage. The LSU 113 radiates the light onto the charged surface of the photosensitive drum 110 to form a first latent electrostatic image that will be developed with a first color on a predetermined position of the photosensitive drum 110. In a case where the developer unit 113 develops the latent electrostatic image on the photosensitive drum 110 with the first color, i.e., yellow, the yellow developer 113a accesses the photosensitive drum 110 to develop the first latent electrostatic image on the photosensitive drum 110 with a toner of yellow color.

A first transfer nip N1 is provided to transfer the developed yellow toner image to the transfer belt 114. A second latent electrostatic image that will be developed with a second color is formed through a process of charging and exposing the photosensitive drum 110. If the second color is magenta, the magenta developer 13b accesses the photosensitive drum 110 to develop the second latent electrostatic image. The developed magenta toner image is overlapped on the transfer belt 114 to which the yellow toner image has been already transferred. A cyan toner image and a black toner image are developed and transferred by this method to finally complete a desired color image on the transfer belt 114. The complete color image is transferred on the paper which is supplied to a second transfer nip N2 between the transfer belt 114 and the second transfer roller 114b, pressed on the paper with high temperature when the paper passes through the fixing unit 115 and the transfer belt 114, and permanently fixed on the paper.

The photosensitive drum 110 used in the electrophotographic color image forming apparatus has a structure in which a cylindrical photosensitive belt is wound around the photosensitive drum 110, a cross-sectional view of which is shown in FIG. 4. Referring to FIG. 4, the photosensitive drum 110 includes a rotary drum 110a and a cylindrical photosensitive belt 110b that closely contacts the circumferential surface of the rotary drum 110a. The rotary drum 110a is made of aluminium or an aluminium alloy and has a diameter of about 150-200 mm. The photosensitive belt 110b is formed of a sequential stack of a base layer, a conductive layer, and a photosensitive layer, and has a thickness of about 20-1000 μm. When light is radiated onto the surface of the photosensitive belt 110b, electrons of the photosensitive layer pass through the conductive layer to an outside of the photosensitive belt 110b to form a latent electrostatic image. The base layer of the photosensitive belt 110b is in contact with the circumferential surface of the rotary drum 110a.

A method of fabricating the photosensitive drum 110 will be described. The rotary drum 110a and the cylindrical photosensitive belt 110b that will be put on (inserted around) the rotary drum 110a are prepared. Here, the photosensitive belt 110b is manufactured to have the same inside diameter as an outside diameter of the rotary drum 110a at an ambient temperature.

The rotary drum 110a is cooled down to a predetermined temperature, possibly −20° C., to be shrunk in diameter or volume. Here, a shrinking degree of the rotary drum 110a depends on a coefficient of thermal expansion of a material of the rotary drum 110a. In general, the coefficient of thermal expansion of aluminium, of which the rotary drum 110a is made, is 23×10⁻⁶ cm/cm/° C.

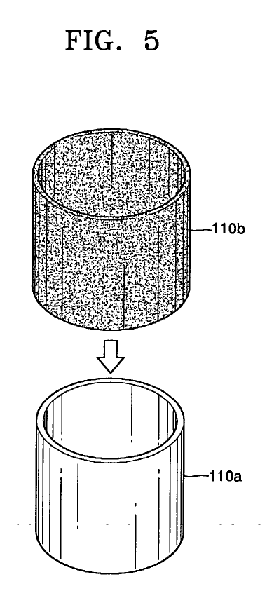

After the rotary drum 110a is maintained cooled and shrunk, the cylindrical photosensitive belt 11b is inserted around the rotary drum 110a, as shown in FIG. 5.

If the rotary drum 110a which is cooled down to the predetermined temperature is restored to the ambient temperature, the rotary drum 110a is gradually expanded in diameter or volume. As a result, the photosensitive belt 110b closely and tightly contacts the circumferential surface of the rotary drum 110a.

The photosensitive belt 110b is maintained to closely and tightly contact the circumferential surface of the rotary drum 110a in a range of an operating temperature required to operate a desired image forming apparatus.

As described above, in a method of fabricating a photosensitive drum for an electrophotographic color image forming apparatus according to the present invention, a cylindrical photosensitive belt closely and tightly contacts the circumferential surface of a rotary drum using the shrinkage and expansion of the rotary drum according to changes in a temperature of the rotary drum. Thus, it is easy to fabricate the photosensitive drum. Also, since an inexpensive photosensitive belt is used, the fabricating cost of the photosensitive drum can be reduced.

Further, in a case where the photosensitive drum that is fabricated according the present invention is used in an image forming apparatus, the uniformity of an image can be achieved. Thus, an additional steering unit is unnecessary.

Although a few preferred embodiments of the present invention have been particularly shown and described, it will be understood and appreciated by those skilled in the art that various changes may be made in the embodiment without departing from the principles and the spirit of the invention, the scope of which is defined in the claims and their equivalents.

What is claimed is:

1. A method of fabricating a photosensitive drum of an electrophotographic color image forming apparatus, comprising:
shrinking and expanding a rotary drum in diameter or volume; and
causing a cylindrical photosensitive belt to closely contact a circumferential surface of the rotary drum using the shrinkage and expansion of the rotary drum according to a temperature change of the rotary drum.

2. The method of claim 1, wherein the shrinking and the expanding of the rotary drum and the causing of the cylindrical photosensitive belt comprises:
cooling the rotary drum from an ambient temperature down to a predetermined temperature so as to be shrunk;
putting the photosensitive belt on the shrunk rotary drum; and
restoring the shrunk rotary drum to the ambient temperature so that the photosensitive belt closely contacts the circumferential surface of the rotary drum.

3. A method of fabricating a photosensitive drum of an electrophotographic color image forming apparatus, comprising:
first-controlling a rotary drum in volume;
inserting the rotary drum into a cylindrical photosensitive belt; and
second-controlling the rotary drum in volume when the cylindrical photosensitive belt is inserted around the rotary drum.

4. The method of claim 3, wherein the first-controlling of the rotary drum comprises:
lowering a temperature of the rotary drum down to a temperature lower than an ambient temperature.

5. The method of claim 3, wherein the first-controlling of the rotary drum comprises:
cooling the rotary drum to a temperature to reduce the rotary drum in diameter or volume.

6. The method of claim 3, wherein the first-controlling of the rotary drum comprises:
maintaining the rotary drum at a temperature to reduce the rotary drum in diameter or volume until the rotary drum is inserted into the cylindrical photosensitive belt.

7. The method of claim 3, wherein the first-controlling of the rotary drum comprises:
maintaining the rotary drum in the reduced diameter until the rotary drum is inserted into the cylindrical photosensitive belt.

8. The method of claim 3, wherein the first-controlling of the rotary drum comprises:
cooling the rotary drum to about −20° C. lower than an ambient temperature.

9. The method of claim 3, wherein the first-controlling of the rotary drum comprises:
reducing the rotary drum in diameter.

10. The method of claim 3, wherein the first-controlling of the rotary drum comprises:
shrinking the rotary drum in diameter or volume.

11. The method of claim 3, wherein the first-controlling of the rotary drum comprises:
reducing the rotary drum by a coefficient of about 23×10⁻⁶ cm/cm/° C.

12. The method of claim 3, wherein the rotary drum and the cylindrical photosensitive belt each are a solid material before being fabricated into the photosensitive drum.

13. The method of claim 3, wherein the rotary drum and the cylindrical photosensitive belt are separated and independently made from each other.

14. The method of claim 3, wherein the rotary drum and the cylindrical photosensitive belt have the same diameter before the rotary drum is first-controlled.

15. The method of claim 3, wherein the second-controlling of the rotary drum comprises:
increasing the rotary drum in diameter after the cylindrical photosensitive belt is inserted around the rotary drum.

16. The method of claim 3, wherein the second-controlling of the rotary drum comprises:
changing a temperature of the rotary drum to an ambient temperature.

17. A method of fabricating a photosensitive drum of an electrophotographic color image forming apparatus, comprising:
changing a diameter of a rotary drum in diameter: and
inserting a cylindrical photosensitive belt around the rotary drum during changing of the diameter of the rotary drum.

18. The method of claim 17, wherein the controlling of the rotary drum comprises:
changing the rotary drum by using shrinkage and expansion of the rotary drum.

19. The method of claim 17, wherein the changing of the diameter of the rotary drum comprises:
changing a temperature of the rotary drum before and after the rotary drum is inserted into the cylindrical photosensitive belt until the rotary drum is secured to the cylindrical photosensitive belt.
